(19) United States
(12) Patent Application Publication
(10) Pub. No.: US 2005/0207041 A1
(43) Pub. Date: Sep. 22, 2005

(54) Exterior rear view mirror for vehicles, more particularly for motor vehicles

(75) Inventor: Robert Apfelbeck, Platting (DE)

Correspondence Address: WARN, HOFFMANN, MILLER & LALONE, .P.C, PO BOX 70098, ROCHESTER HILLS, MI, 48307, US

(73) Assignee: Schefenacker Vision Systems Germany GmbH & Co. KG, Esslingen (DE)

(21) Appl. No.: 10/506,585

(22) PCT Filed: Feb. 14, 2003
(86) PCT No.: PCT/DE03/00443

§ 371 Date: May 12, 2005

(30) Foreign Application Priority Data
Mar. 5, 2002 (DE) 102 09 628.7

(51) Int. Cl. G02B 7/182

(52) U.S. Cl. 359/871; 362/487

(57) ABSTRACT

In order to configure an exterior rear view mirror (1) in such a way that area next to the vehicle is perfectly illuminated by the surround light (6) in a simple, constructive manner even when the mirror head (2) is folded, said light is fixedly arranged in relation to the mirror head (2). Said mirror head (2) also has a passage hole (18) for the beams coming out of the surround light (6) due to the fact that the position of the surround light (6) remains unchanged when it is in working position or in folded position. The exterior rear view mirror (1) ensures optimum illumination in the area below the mirror and next to the vehicle in every position of the mirror head (2).

The invention concerns an exterior rearview mirror for vehicles, more particularly for motor vehicles, according to the preamble of claim 1.

In known exterior rearview mirrors of this type, the perimeter light is arranged in the mirror head. Consequently, when the mirror head is folded into the parked position the perimeter light is moved out of its optimal position for illuminating the area next to the vehicle door, so that the perimeter light no longer covers this area.

The object of the invention is to design an exterior rearview mirror of this type such that the area next to the vehicle can be perfectly illuminated by the perimeter light through simple design means even when the mirror head is folded back.

This object is attained in an exterior rearview mirror of the generic type according to the invention with the characterizing features of claim 1.

As a result of the design according to the invention, the perimeter light retains its position unchanged when the mirror head is in both its operating and folded positions. By this means, the perimeter light ensures optimal lighting in the area beneath the mirror and next to the vehicle in all positions of the mirror head.

Additional features of the invention are clear from the additional claims, the description and the drawings.

The invention is described in detail below using an example embodiment shown in the drawing.

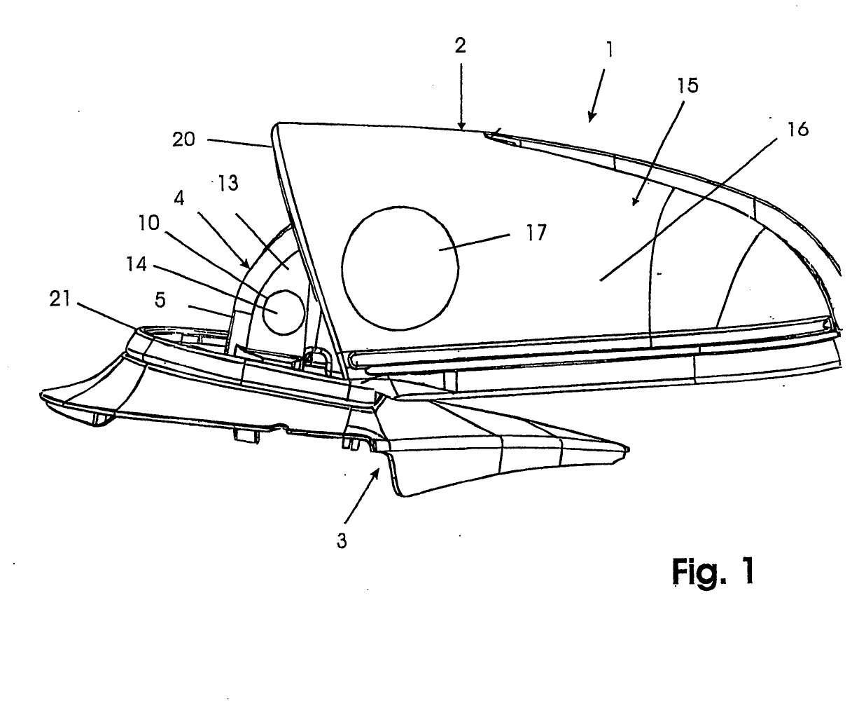

FIG. 1 shows a bottom view of an exterior rearview mirror according to the invention with a mirror head in the folded position,

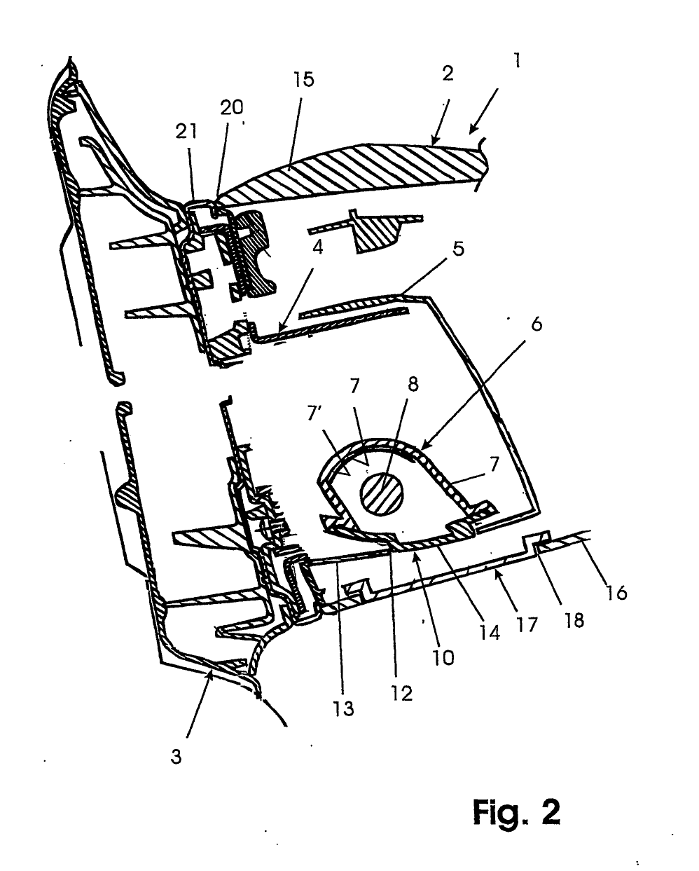

FIG. 2 shows a vertical section of part of the exterior rearview mirror from FIG. 1 with the mirror head in its extended operating position.

The exterior rearview mirror 1 shown in FIGS. 1 and 2 is meant for motor vehicles. It has a mirror head 2 and a mirror base 3 by which it is attached to the body of the motor vehicle. The mirror head 2 is connected to the mirror base 3 by an articulation 4 that is known per se. The articulation 4 is designed in a known manner and thus is not explained further. The articulation 4 has an articulation cover 5 which encloses a perimeter light 6. The perimeter light 6 has a light housing 7 with a reflector 11 on its hemispherically domed bottom 7′, and also has a lighting means 8 located at the center of curvature of the reflector. The light housing 7 has a housing opening 9 that is covered by a first optical window 10. In the example embodiment, the optical window 10 is round and has an essentially central, likewise round, projecting section 14 that extends in an essentially interlocking manner into an opening 12 on the underside 13 of the articulation cover 5. In FIG. 1, this part of the articulation 4, with the optical window 10 and its section 14, can be seen in bottom view. The mirror head 2 has a housing 15 that is open on its side facing the mirror base 3; in the operating position, an edge 20 of the mirror housing 15 rests against the mirror base 3. The mirror base 3 is provided with a raised edge 21 against which the edge 20 of the housing 15 rests. On its underside 16, the housing 15 has a circular opening 18 that is larger than the opening 12 of the articulation cover 5. The opening 18 is covered by an additional optical window 17, which is located beneath the optical window 10 when the mirror head 2 is in the operating position.

In the operating position of the exterior rearview mirror 1, the light emitted by the lighting means 8 falls through the section 14 of the optical window 10 and the optical window 17 downward to the ground area next to the motor vehicle. This makes it possible for the driver or passenger to detect objects, puddles or the like in darkness or conditions of poor visibility.

When the mirror head 2 is folded back into the parked position (FIG. 1), the articulation cover 5 is partly exposed. The optical window 10, and its section 14 in the opening 12, are exposed. The light emitted by the lighting means 8 now falls through the optical window 10 to the same ground area as before, when the mirror head 2 was in its operating position (FIG. 2). This achieves the result that light always falls in the same direction downward next to the vehicle regardless of the position of the mirror head 2.

It is not necessary for an optical window to be arranged in the opening 12, 18. Even in such a case, the light always falls to the same area of the ground regardless of whether the mirror head 2 is folded back or extended. It is equally possible to arrange an optical window in only one of the two openings 12, 18. The optical windows 12, 17 can have a wide variety of shapes.

1. Exterior rearview mirror for vehicles, comprising; a mirror head, having a mirror base attached to the vehicle, said mirror head being coupled to the mirror base in a folding manner, at least one perimeter light for illuminating an area next to the vehicle, said perimeter light being arranged in a fixed position with respect to the mirror head and said mirror head having at least one through-opening for the rays emitted by the perimeter light.

2. Mirror according to claim 1, wherein the perimeter light is attached to an articulation that joins the mirror base and the mirror head.

3. Mirror according to claim 1, further comprising an optical window being set into the through-opening of the mirror head.

4. Mirror according to claim 3, wherein the optical window of the mirror head is provided a distance below the perimeter light.

5. Mirror according to claim 1 wherein the perimeter light is accommodated in an articulation cover.

6. Mirror according to claim 5, wherein the articulation cover projects from the mirror base and extends into the mirror head.

7. Mirror according to claim 5 wherein the articulation cover has at least one through-opening for the rays emitted by the perimeter light.

8. Mirror according to claim 7, wherein the through-opening of the articulation cover and the through-opening of the mirror head are located one above the other when the mirror head is in the operating position.

9. Mirror according to claim 7 wherein an optical window is set into the through-opening of the articulation cover.

10. Mirror according to claim 9, wherein a projecting section of the optical window extends into the through-opening of the housing cover.

11. Mirror according to claim 1 wherein the perimeter light has a housing in which is located at least one source.
